(19) United States
(12) Patent Application Publication
(10) Pub. No.: US 2021/0300354 A1
(43) Pub. Date: Sep. 30, 2021

(54) Systems and Methods for Controlling Operation of a Vehicle Feature According to a Learned Risk Preference

(71) Applicant: Toyota Research Institute, Inc., Los Altos, CA (US)

(72) Inventors: Stephen G. McGill, Broomall, PA (US); Guy Rosman, Newton, MA (US); Luke S. Fletcher, Cambridge, MA (US); Simon Stent, Cambridge, MA (US)

(73) Assignee: Toyota Research Institute, Inc., Los Altos, CA (US)

(21) Appl. No.: 16/836,429

(22) Filed: Mar. 31, 2020

(51) Int. Cl. B60W 30/095; B60W 40/09; G06K 9/00; B60W 30/18

(52) U.S. Cl. CPC B60W 30/0953; B60W 40/09; G06K 9/00845; B60W 50/14; B60W 30/18154; B60W 30/18159; B60W 30/0956

(57) ABSTRACT

Systems, vehicles, devices, and methods for controlling an operation of a vehicle feature according to a learned risk preference are disclosed. An embodiment is a vehicle that controls an operation of a vehicle feature of the vehicle according to an initial risk preference. The operation of the vehicle feature comprises is according to a risk estimate and a driver risk preference that is set to the initial risk preference. The vehicle acquires an observation of a driver behavior. The driver behavior comprises a behavior of the driver when the vehicle is in a context associated with the risk estimate, and represents a risk tolerance of the driver. The vehicle updates the driver risk preference to a learned risk preference based on a comparison of the risk estimate with the risk tolerance of the driver, and controls an operation of the vehicle feature according to the learned risk preference.

### TECHNICAL FIELD

The present disclosure generally relates to automated vehicular control, and more specifically, to systems, vehicles, devices, and methods for controlling an operation of a vehicle feature according to a learned risk preference.

### BACKGROUND

Vehicles (such as autonomous, semi-autonomous, and manually-operated vehicles) are often equipped with a driver-assistance system, which may provide vehicle functions such as adaptive cruise control, lane departure warnings, lane centering, and collision avoidance. These vehicle functions may operate to intervene or aid a driver of the vehicle—for example, by providing information to the driver or setting a trajectory of the vehicle.

### SUMMARY

An embodiment of the present disclosure takes the form of a method that includes controlling an operation of a vehicle feature of a vehicle according to an initial risk preference. The operation of the vehicle feature according to the initial risk preference comprises an operation of the vehicle feature according to a risk estimate and a driver risk preference that is set to the initial risk preference. The method further includes acquiring an observation of a driver behavior. The driver behavior comprises a behavior of the driver when the vehicle is in a context associated with the risk estimate, and the driver behavior represents a risk tolerance of the driver. The method also includes updating the driver risk preference to a learned risk preference based on a comparison of the risk estimate with the risk tolerance of the driver, and controlling an operation of the vehicle feature according to the learned risk preference.

Another embodiment takes the form of a vehicle that comprises a vehicle feature, a processor, and a non-transitory computer-readable storage medium comprising instructions. The instructions, when executed by the processor, cause the vehicle to control an operation of the vehicle feature according to an initial risk preference. The operation of the vehicle feature according to the initial risk preference comprises an operation of the vehicle feature according to a risk estimate and a driver risk preference that is set to the initial risk preference. The instructions further cause the vehicle to acquire an observation of a driver behavior. The driver behavior comprises a behavior of the driver when the vehicle is in a context associated with the risk estimate, and the driver behavior represents a risk tolerance of the driver. The instructions also cause the vehicle to update the driver risk preference to a learned risk preference based on a comparison of the risk estimate with the risk tolerance of the driver, and to control an operation of the vehicle feature according to the learned risk preference.

A further embodiment takes the form of a method that includes controlling an operation of a vehicle user interface of a vehicle according to an initial risk preference. The operation according to the initial risk preference comprises an operation to present risk feedback via the vehicle user interface according to a risk estimate of a risk and a driver risk preference that is set to the initial risk preference. The method further includes acquiring an observation of a driver behavior, the driver behavior comprising a behavior of a driver of the vehicle when the vehicle is in a context associated with the risk estimate. The driver behavior reflects that the driver is tolerant to the risk. The method also includes updating the driver risk preference to a learned risk preference based on a comparison of the risk estimate with the driver behavior reflecting that the driver is tolerant to the risk. Additionally, the method includes controlling an operation of the vehicle user interface according to the learned risk preference. The operation according to the learned risk preference comprises an operation to suppress risk feedback via the vehicle user interface.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a block diagram of a vehicle, according to one or more embodiments illustrated and described herein;

FIG. 2 depicts a flowchart of a method, according to one or more embodiments illustrated and described herein; and

FIG. 3 depicts aspects of a vehicle context, according to one or more embodiments described and illustrated herein.

### DETAILED DESCRIPTION

Systems, vehicles, computing devices, and methods for controlling an operation of a vehicle feature according to a learned risk preference are disclosed herein. In some embodiments, a vehicle controls an operation of a vehicle feature of the vehicle according to an initial risk preference. The operation of the vehicle feature according to the initial risk preference comprises an operation of the vehicle feature according to a risk estimate and a driver risk preference that is set to the initial risk preference. The vehicle acquires an observation of a driver behavior. The driver behavior comprises a behavior of the driver when the vehicle is in a context associated with the risk estimate, and the driver behavior represents a risk tolerance of the driver. The vehicle updates the driver risk preference to a learned risk preference based on a comparison of the risk estimate with the risk tolerance of the driver, and controls an operation of the vehicle feature according to the learned risk preference. By learning a risk preference of a driver, operation of the vehicle feature can be tailored according to the risk preference—for instance, by suppressing future warnings to the driver regarding potential risks with respect to vehicle operation. Various embodiments of systems, vehicles, computing devices, and methods for controlling an operation of a vehicle feature according to a learned risk preference will now be described in detail with reference to the drawings.

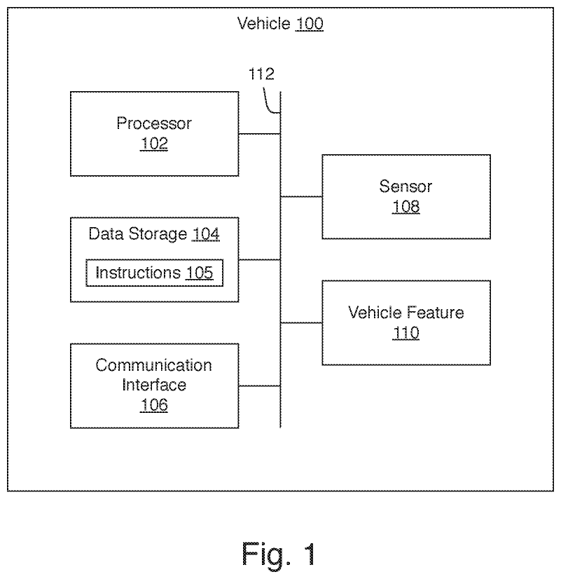

FIG. 1 depicts a block diagram of a vehicle, according to one or more embodiments described and illustrated herein. As shown, a vehicle 100 includes a processor 102, a data storage 104 including instructions 105, a communication interface 106, a sensor 108, and a vehicle feature 110, each of which are communicatively connected via a system bus 112. It should be understood that vehicle 100 may include different and/or additional components, and some or all of the functions of a given component could instead be carried out by one or more different components. The processor, data storage, communication interface, sensor, and vehicle feature may collectively form a computing device. Vehicle 100 could take the form of an autonomous vehicle, a semi-autonomous vehicle, or a manually-operated vehicle, among other possibilities.

Processor 102 may take the form of one or more general-purpose processors and/or one or more special-purpose processors, and may be integrated in whole or in part with data storage 104, communication interface 106, sensor 108, vehicle feature 110, and/or any other component of vehicle 100, as examples. Accordingly, processor 102 may take the form of or include a controller, an integrated circuit, a microchip, a central processing unit (CPU), a microprocessor, a system on a chip (SoC), a field-programmable gate array (FPGA), and/or an application-specific integrated circuit (ASIC), among other possibilities.

Data storage 104 may take the form of a non-transitory computer-readable storage medium such as a hard drive, a solid-state drive, an erasable programmable read-only memory (EPROM), a universal serial bus (USB) storage device, a compact disc read-only memory (CD-ROM) disk, a digital versatile disc (DVD), a relational database management system (RDBMS), any other non-volatile storage, or any combination of these, to name just a few examples.

Instructions 105 may be stored in data storage 104, and may include machine-language instructions executable by processor 102 to cause vehicle 100 to perform the vehicle functions described herein. Additionally or alternatively, instructions 105 may include script instructions executable by a script interpreter configured to cause processor 102 and vehicle 100 to execute the instructions specified in the script instructions. It should be understood that instructions 105 may take other forms as well.

Additional data may be stored in data storage 104, such as data indicating a driver risk preference, as will be described in further detail below. The additional data could be stored as a table, a flat file, data in a filesystem of the data storage, a heap file, a B+ tree, a hash table, a hash bucket, or any combination of these, as examples.

Communication interface 106 may be any component capable of performing the communication-interface functions described herein, including facilitating wired and/or wireless communication between vehicle 100 and another entity (such as vehicle or other road agent). As such, communication interface 106 could take the form of an Ethernet, Wi-Fi, Bluetooth, and/or USB interface, among many other examples. Communication interface 106 may receive data over a network 114 via one or more communication links, for instance.

Sensor 108 could take the form of one or more sensors operable to perform any of the sensor functions described herein, including one or more sensors operable to identify a context of vehicle 100, for example. The sensor could be positioned on an interior and/or exterior of vehicle 100. Though sensor 108 may be referenced in the singular throughout this disclosure, it should be understood that sensor 108 may take the form of (or include) a single sensor or multiple sensors.

The sensor could include a radar sensor, a lidar sensor, a camera, an accelerometer, a speedometer, or any combination of these or other sensors. The radar sensor, lidar sensor, and/or camera may obtain signals (such as electromagnetic radiation) that can be used by vehicle 100 to obtain information regarding an environment of the vehicle. For example, the radar sensor and/or lidar sensor may send a signal (such as pulsed laser light or radio waves) and may obtain a distance measurement from the sensor to the surface of a road agent or other object based on a time of flight of the signal—that is, the time between when the signal is sent and when the reflected signal (reflected by the object surface) is received by the sensor. The camera may collect light or other electromagnetic radiation and may generate an image representing a trajectory of a road agent or an environment of a system entity based on the collected radiation. Additionally or alternatively, the accelerometer and the speedometer may be used to detect an acceleration and a speed, respectively, of vehicle 100 or another road agent. Sensor 108 may take other forms as well.

Vehicle feature 110 may be any component capable of carrying out the vehicle feature functions described herein. The vehicle feature could take the form of (or include) an adaptive cruise control feature, a lane departure warning feature, an automatic lane centering feature, a blind spot detection feature, a collision avoidance feature, or a combination of these or other vehicle features, as examples. In some embodiments, vehicle feature 110 includes an electronic control unit (ECU), instructions 205 executable by processor 202 to cause vehicle 100 and vehicle feature 110 to perform the vehicle feature functions, or a combination of these, among other possibilities. As an example, the vehicle feature could function to display a notification to a driver of vehicle 100, to change a trajectory of the vehicle, or to apply a vehicle brake. Vehicle feature 110 is described in additional detail below.

System bus 112 may be any component capable of performing the system-bus functions described herein. In an embodiment, system bus 112 is any component configured to transfer data between processor 102, data storage 104, communication interface 106, sensor 108, vehicle feature 110, and/or any other component of vehicle 100. In an embodiment, system bus 112 includes a traditional bus as is known in the art. In other embodiments, system bus 112 includes a serial RS-232 communication link, a USB communication link, and/or an Ethernet communication link, alone or in combination with a traditional computer bus, among numerous other possibilities. In some examples, system bus 112 may be formed from any medium that is capable of transmitting a signal, such as conductive wires, conductive traces, or optical waveguides, among other possibilities. Moreover, system bus 112 may be formed from a combination of mediums capable of transmitting signals. The system bus could take the form of (or include) a vehicle bus, such as a local interconnect network (LIN) bus, a controller area network (CAN) bus, a vehicle area network (VAN) bus, or any combination of these or mediums. It should be understood that system bus 112 may take various other forms as well.

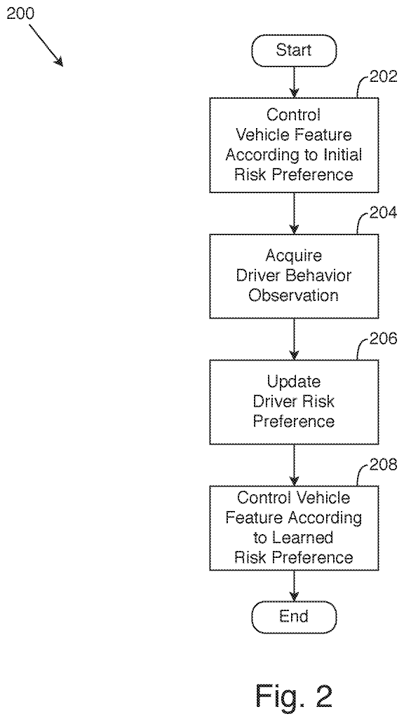

FIG. 2 depicts a flowchart of a method, according to one or more embodiments illustrated and described herein. Though the method is described as being carried out by vehicle 100, it will be appreciated that the method could be carried out by a component or combination of components of vehicle 100 or another entity. For instance, vehicle 100 could include an ECU or other computing device, and vehicle 100 carrying out the method could include the ECU or other computing device carrying out the method. As another possibility, vehicle 100 could be connected to a server over a network and one or more communication links via communication interface 106, and the method could be carried out by the server. Other examples are possible as well without departing from the scope of the disclosure.

As shown, a method 200 begins at step 202 with vehicle 100 controlling an operation of vehicle feature 110 according to an initial risk preference. The operation of the vehicle feature according to the initial risk preference includes an operation of vehicle feature 110 according to a risk estimate and a driver risk preference that is set to the initial risk preference. The risk estimate may comprise an estimate of a given risk.

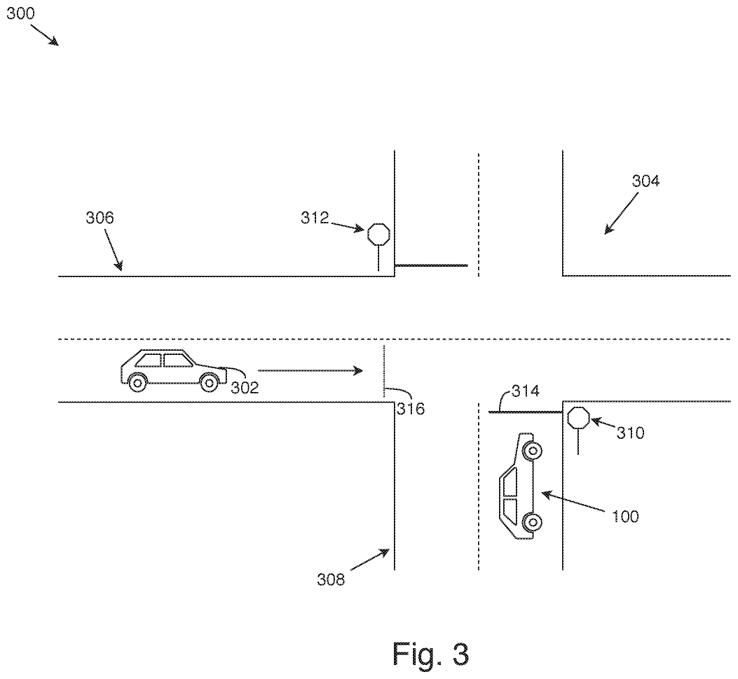

FIG. 3 depicts aspects of a vehicle context that may be associated with a risk estimate, according to one or more embodiments described and illustrated herein. As shown, a context 300 includes a road agent 302 that is approaching an intersection 304 on roadway 306. Intersection 304 is an intersection of roadway 306 with a roadway 308 on which the vehicle is traveling. Roadway 306 forms two legs of the intersection, and roadway 308 forms two other legs of the intersection. The legs formed by roadway 308 both have stop signs 310 and 312 at the entrance to the intersection, indicating that vehicles approaching the intersection on these legs (e.g., vehicle 100) are required to stop at the entrance to the intersection and wait for other road agents traveling on roadway 306 to exit the intersection before the vehicles are permitted to enter the intersection. As shown, an entrance 314 identifies an entrance into intersection 304 for the leg of roadway 308 on which vehicle 100 is traveling, and an entrance 316 identifies an entrance into the intersection for the leg of roadway 306 on which vehicle 100 is approaching the intersection. The legs formed by roadway 306 do not have any traffic control signs at the entrance to the intersection and thus any road agents traveling on roadway 306 (e.g., road agent 302) have right of way through the intersection with respect to vehicles (e.g., vehicle 100) approaching the intersection on the legs formed by roadway 308.

A vehicle context may include a geometry of a road in proximity to vehicle 100, a position of a road agent 302 (or another road agent), a trajectory of road agent 302, a velocity of road agent 302, a time of day, a weather condition at the time of day, or a combination of these or other aspects. For instance, context 300 could include a geometry of roadway 308 on which vehicle 100 is traveling, a geometry of roadway 308 on which road agent 302 is traveling, a geometry of intersection 304, or a combination of these, as examples. As another possibility, the context could include a position p of road agent 302, a velocity v of the road agent, a trajectory of the road agent, or another characteristic of the road agent, The context could similarly include a position of vehicle 100, a velocity of the vehicle, a trajectory of the vehicle, or another characteristic of the vehicle. Context 300 shown in FIG. 3 could be a context at a given time of day, and thus the context could include the time of day or a weather condition at the time of day, among numerous other examples.

In some embodiments, vehicle 100 generates the risk estimate based on a vehicle context of vehicle 100, such as context 300. The risk could be a risk of a collision, such as a collision between vehicle 100 and road agent 302 in context 300, or a collision between vehicle 100 and a stationary object such as road debris present on roadway 308 ahead of vehicle 100. The risk could be a risk of one or more tires of vehicle 100 losing traction or acceleration because of weather conditions of context 300.

In an embodiment, the risk includes a risk that a road agent deceleration—for instance, a deceleration by road agent 302 to avoid entering intersection 304 as a result of a behavior of vehicle 100—would exceed a threshold deceleration. In this embodiment, the threshold deceleration is referred to colloquially as an “uncomfortable” deceleration threshold by road agent 302 such that a driver of the road agent could feel discomfort (an uncomfortable deceleration) as a result of a deceleration that exceeds the threshold deceleration. However, it should be understood that the threshold deceleration could be a different threshold deceleration, regardless of a discomfort to the driver of road agent 302.

An uncomfortable deceleration could result from vehicle 100 entering the intersection such that road agent 302 would be required to decelerate to avoid a collision between vehicle 100 and road agent 302, and specifically such that the required deceleration by vehicle 100 would exceed the uncomfortable deceleration threshold. For instance, even though road agent 302 has right of way through intersection 304 (with respect to vehicle 100), vehicle 100 may make a right turn at intersection 304 and onto roadway 306 on which road agent 302 is approaching the intersection. The right turn may require an uncomfortable deceleration by road agent 302 to avoid a collision with vehicle 100. In such an example, the risk estimate could be an estimated risk that road agent 302 would experience an uncomfortable deceleration if vehicle 100 were to make a right turn at intersection 304.

In some embodiments, vehicle 100 controls an operation of vehicle feature 110 based on a risk estimate associated with a given context. For instance, if vehicle 100 estimates a high risk of collision between vehicle 100 and road agent 302, vehicle 100 could control an operation of a collision avoidance feature of the vehicle according to this high risk estimate so as to avoid a collision between the vehicle and the road agent. The collision avoidance feature may operate to change a trajectory of vehicle 100 and/or apply one or more brakes of vehicle 100 so as to avoid a collision with the road agent. As another example, the collision avoidance feature could operate to present feedback to the driver of vehicle 100 indicating the estimated risk of collision with road agent 302. The feedback could be presented on a dashboard of vehicle 100 (or another display of the vehicle), and could include a visual warning of a potential collision with road agent 302. As another possibility, the feedback could be presented via a speaker of vehicle 100, and could include an audible warning of the potential collision. Vehicle feature 110 could include a vehicle user interface such as a dashboard, a heads-up display, a speaker, a linear resonant actuator, or another user interface of the vehicle, and vehicle 100 may control operation of the vehicle user interface based on a risk estimate by presenting risk feedback via the vehicle user interface. The risk feedback could include a visual, audible, tactile, or other feedback (or any combination of these). Other examples are possible as well.

Context 300 may include a detected trajectory and a detected velocity of road agent 302 approaching intersection 304 through which the road agent has right of way with respect to vehicle 100. The trajectory and the velocity could be detected, for instance, via sensor 108 of vehicle 100. The context could also include a forecasted distance between vehicle 100 and road agent 302 at a given time to were vehicle 100 to cross intersection 304 (e.g., by entering the intersection from entrance 314) at time to and were road agent 302 to maintain the detected trajectory and the detected velocity. For instance, a forecasted distance of zero meters may reflect a forecasted collision between vehicle 100 and road agent 302 at time to, while a forecasted distance of three meters may reflect a forecast of a near miss between vehicle 100 and road agent 302.

The context may also include a threshold deceleration by road agent 302 to avoid entering intersection 304 if the forecasted distance is less than a threshold distance. The threshold distance may reflect a prediction by vehicle 100 that a driver of road agent 302 would attempt to stop the road agent before entering intersection 304, if the driver of the road agent were to judge that the road agent would come within the threshold distance to vehicle 100 in the intersection by maintaining the detected trajectory and the detected velocity.

In such an embodiment, the risk estimate generated based on the above-described context could include an estimated risk that the forecasted distance described above would be less than the threshold distance if vehicle 100 were to enter into and cross intersection 304 as described above. The risk estimate could also include an estimated risk that a deceleration by the road agent would exceed the threshold deceleration if the vehicle were to enter into and cross the intersection. Vehicle feature 110 could control operation of a vehicle user interface (or other vehicle feature) based on such a risk estimate by presenting risk feedback that includes an alert to the driver, warning the driver of the risk were the driver to cross the intersection in the given context associated with the risk estimate. It should be noted that the forecasted distance at the given time could be greater than a zero distance, such that the deceleration by the road agent would exceed the threshold deceleration but that a collision would not result in a collision were to enter into and cross the intersection.

Vehicle 100 may control an operation of vehicle feature 110 according to a driver risk preference, which may be learned by the vehicle based on observation of behaviors of the driver of vehicle 100. As noted above, at step 202, vehicle 100 controls an operation of vehicle feature 110 according to an initial risk preference, which in some embodiments includes the vehicle controlling operation of the vehicle feature according to a driver risk preference that is set to the initial risk preference. As the vehicle learns (e.g., continues to learn) the driver risk preference, subsequent operation of the vehicle feature may be in accordance with the learned driver risk preference. In some embodiments, vehicle 100 controls an operation of vehicle feature 110 according to both (i) a risk estimate and (ii) a driver risk preference (e.g., that is set to an initial risk preference, a learned risk preference, etc.). Additional details regarding the driver risk preference and controlling operation of the vehicle feature according to the driver risk preference are provided below.

At step 204, vehicle 100 acquires an observation of a driver behavior, which is a behavior of a driver of vehicle 100 when the vehicle is in a context associated with the risk estimate of step 202. The driver behavior represents a risk tolerance of the driver. For instance, the risk tolerance of the driver represented by the driver behavior may reflect that the driver is tolerant to the risk estimate, or could reflect that the driver is intolerant to the risk estimate.

As an example, a behavior of the driver could include the vehicle (as operated by the driver) crossing intersection 304 at a time when the threshold deceleration by road agent 302 to avoid entering the intersection would exceed the threshold deceleration described above. In this example, the risk tolerance represented by the behavior of the driver may reflect a tolerance of the risk estimate—that is, the risk tolerance represented by the driver behavior may reflect that the driver was tolerant of the risk that a deceleration by the road agent may exceed the threshold deceleration.

At step 206, vehicle 100 updates the driver risk preference to a learned risk preference based on a comparison of the risk estimate with the risk tolerance of the driver. For instance, vehicle 100 may estimate that risk of performing the driver behavior, as that risk was perceived by the driver, was a risk that was tolerable to the driver. Such an estimate may be based on an assumption that the vehicle driver would be aware that, by crossing the intersection at the given time, road agent 302 may have to stop before entering (i.e., avoid entering) intersection 304 so that vehicle 100 could first cross the intersection. The estimate may be further based on an assumption that the driver would be aware of the possibility that a driver of the road agent would experience discomfort by the deceleration of the road agent that would be required to avoid entering the intersection. Additionally, the estimate may be based on assumption that, by crossing the intersection at the given time, the driver concluded that the risk of the other driver experiencing such discomfort—as that risk is perceived by the driver, is a risk tolerable to the driver. Vehicle 100 may update the driver risk preference to a learned risk preference based on the observation that vehicle 100 crossed the intersection at the given time, and specifically based on a comparison of the observation with an estimated tolerance of the risk that the driver of the road agent would experience discomfort as a result of the driver behavior observed by the vehicle.

At step 208, vehicle 100 controls an operation of the vehicle feature according to the learned risk preference. In an example, subsequent to updating the driver risk preference at step 206, vehicle 100 generates a risk estimate associated with a context similar to context 300, such that a driver of a road agent could experience an uncomfortable deceleration if the driver of vehicle 100 were to perform a given behavior in the similar context (e.g., by crossing an intersection at a given time). Were the vehicle controlling an operation of vehicle feature 110 according to the initial risk preference and the risk estimate associated with the similar context, the operation of the vehicle feature may have included an operation of a vehicle user interface to present risk feedback via the vehicle user interface, such as an alert that warns the driver of the risk of crossing the intersection. However, controlling an operation of vehicle feature 110 according to the learned risk preference (and the risk estimate associated with the similar context) may include an operation of the vehicle user interface to suppress (rather than present) the risk feedback via the vehicle user interface. Other examples are possible as well without departing from the scope of the disclosure, as will be appreciated by those of skill in the art.

It should now be understood that embodiments described herein are directed to systems, vehicles, computing devices, and methods for controlling an operation of a vehicle feature according to a learned risk preference. In some embodiments, a vehicle controls an operation of a vehicle feature of the vehicle according to an initial risk preference. The operation of the vehicle feature according to the initial risk preference comprises an operation of the vehicle feature according to a risk estimate and a driver risk preference that is set to the initial risk preference. The vehicle acquires an observation of a driver behavior. The driver behavior comprises a behavior of the driver when the vehicle is in a context associated with the risk estimate, and the driver behavior represents a risk tolerance of the driver. The vehicle updates the driver risk preference to a learned risk preference based on a comparison of the risk estimate with the risk tolerance of the driver, and controls an operation of the vehicle feature according to the learned risk preference. By learning a risk preference of a driver, operation of the vehicle feature can be tailored according to the risk preference—for instance, by suppressing future warnings to the driver regarding potential risks with respect to vehicle operation.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method comprising:
controlling an operation of a vehicle feature of a vehicle according to an initial risk preference, the operation of the vehicle feature according to the initial risk preference comprising an operation of the vehicle feature according to a risk estimate and a driver risk preference that is set to the initial risk preference;
acquiring an observation of a driver behavior, the driver behavior comprising a behavior of a driver of the vehicle when the vehicle is in a context associated with the risk estimate, the driver behavior representing a risk tolerance of the driver;
updating the driver risk preference to a learned risk preference based on a comparison of the risk estimate with the risk tolerance of the driver; and
controlling an operation of the vehicle feature according to the learned risk preference.

2. The method of claim 1, wherein the context comprises at least one of a geometry of a road in proximity to the vehicle, a position of a road agent, a trajectory of the road agent, a velocity of the road agent, a time of day, and a weather condition at the time of day.

3. The method of claim 1, wherein the context comprises:
a detected trajectory and a detected velocity of a road agent approaching an intersection through which the road agent has right of way with respect to the vehicle,
a forecasted distance between the vehicle and the road agent at a given time were the vehicle to cross the intersection at the given time and were the road agent to maintain the detected trajectory and the detected velocity, and
a threshold deceleration by the road agent to avoid entering the intersection if the forecasted distance is less than a threshold distance.

4. The method of claim 3, wherein the risk estimate reflects an estimated risk that a deceleration by the road agent would exceed the threshold deceleration were the vehicle to cross the intersection at the given time.

5. The method of claim 3, wherein:
the observation of the driver behavior comprises an observation of the vehicle crossing the intersection at the given time, and
the driver behavior represents a risk tolerance that a deceleration by the road agent exceeds the threshold deceleration.

6. The method of claim 3, wherein the forecasted distance at the given time would be greater than a zero distance.

7. The method of claim 1, wherein:
the operation of the vehicle feature according to the initial risk preference comprises an operation of a vehicle user interface to present risk feedback via the vehicle user interface,
the risk tolerance reflects that the driver is tolerant to the risk estimate, and
the operation of the vehicle feature according to the learned risk preference comprises an operation of the vehicle user interface to suppress risk feedback via the vehicle user interface.

8. A vehicle comprising:
a vehicle feature,
a processor, and
a non-transitory computer-readable storage medium comprising instructions that, when executed by the processor, cause the vehicle to
control an operation of the vehicle feature according to an initial risk preference, the operation of the vehicle feature according to the initial risk preference comprising an operation of the vehicle feature according to a risk estimate and a driver risk preference that is set to the initial risk preference;
acquire an observation of a driver behavior, the driver behavior comprising a behavior of the driver when the vehicle is in a context associated with the risk estimate, the driver behavior representing a risk tolerance of the driver;
update the driver risk preference to a learned risk preference based on a comparison of the risk estimate with the risk tolerance of the driver; and
control an operation of the vehicle feature according to the learned risk preference.

9. The vehicle of claim 8, wherein the context comprises at least one of a geometry of a road in proximity to the vehicle, a position of a road agent, a trajectory of the road agent, a velocity of the road agent, a time of day, and a weather condition at the time of day.

10. The vehicle of claim 8, wherein the context comprises:
a detected trajectory and a detected velocity of a road agent approaching an intersection through which the road agent has right of way with respect to the vehicle,
a forecasted distance between the vehicle and the road agent at a given time were the vehicle to cross the intersection at the given time and were the road agent to maintain the detected trajectory and the detected velocity, and
a threshold deceleration by the road agent to avoid entering the intersection if the forecasted distance is less than a threshold distance.

11. The vehicle of claim 10, wherein the risk estimate reflects an estimated risk that a deceleration by the road agent would exceed the threshold deceleration were the vehicle to cross the intersection at the given time.

12. The vehicle of claim 10, wherein:
the observation of the driver behavior comprises an observation of the vehicle crossing the intersection at the given time, and
the driver behavior represents a risk tolerance that a deceleration by the road agent exceeds the threshold deceleration.

13. The vehicle of claim 10, wherein the forecasted distance at the given time would be greater than a zero distance.

14. The vehicle of claim 8, wherein:
the operation of the vehicle feature according to the initial risk preference comprises an operation of a vehicle user interface to present risk feedback via the vehicle user interface,
the risk tolerance reflects that the driver is tolerant to the risk estimate, and
the operation of the vehicle feature according to the learned risk preference comprises an operation of the vehicle user interface to suppress risk feedback via the vehicle user interface.

15. A method comprising:
controlling an operation of a vehicle user interface of a vehicle according to an initial risk preference, the operation according to the initial risk preference comprising an operation to present risk feedback via the vehicle user interface according to a risk estimate of a risk and a driver risk preference that is set to the initial risk preference;
acquiring an observation of a driver behavior, the driver behavior comprising a behavior of a driver of the vehicle when the vehicle is in a context associated with the risk estimate, the driver behavior reflecting that the driver is tolerant to the risk;
updating the driver risk preference to a learned risk preference based on a comparison of the risk estimate with the driver behavior reflecting that the driver is tolerant to the risk; and
controlling an operation of the vehicle user interface according to the learned risk preference, the operation according to the learned risk preference comprising an operation to suppress risk feedback via the vehicle user interface.

16. The method of claim 16, wherein the context comprises at least one of a geometry of a road in proximity to the vehicle, a position of a road agent, a trajectory of the road agent, a velocity of the road agent, a time of day, and a weather condition at the time of day.

17. The method of claim 16, wherein the context comprises:
a detected trajectory and a detected velocity of a road agent approaching an intersection through which the road agent has right of way with respect to the vehicle,
a forecasted distance between the vehicle and the road agent at a given time were the vehicle to cross the intersection at the given time and were the road agent to maintain the detected trajectory and the detected velocity, and
a threshold deceleration by the road agent to avoid entering the intersection if the forecasted distance is less than a threshold distance.

18. The method of claim 18, wherein the risk estimate reflects an estimated risk that a deceleration by the road agent would exceed the threshold deceleration were the vehicle to cross the intersection at the given time.

19. The method of claim 18, wherein:
the observation of the driver behavior comprises an observation of the vehicle crossing the intersection at the given time, and
the driver behavior represents a risk tolerance that a deceleration by the road agent exceeds the threshold deceleration.

20. The method of claim 18, wherein the forecasted distance at the given time would be greater than a zero distance.
